(19) United States
(12) Patent Application Publication
(10) Pub. No.: US 2014/0176967 A1
(43) Pub. Date: Jun. 26, 2014

(54) COLORIMETRIC RENDERING

(71) Applicant: HEWLETT- PACKARD DEVELOPMENT COMPANY, L.P., Houston, TX (US)

(72) Inventors: Nathan Moroney, Palo Alto, CA (US); Nina Bhatti, Los Altos, CA (US); Kok-Wei Koh, Mountain View, CA (US); Melanie M. Gottwals, San Jose, CA (US)

(73) Assignee: HEWLETT-PACKARD DEVELOPMENT COMPANY, L.P., Houston, TX (US)

(21) Appl. No.: 13/722,854

(22) Filed: Dec. 20, 2012

(51) Int. Cl. G06T 11/00; G06K 15/02

(52) U.S. Cl. CPC G06T 11/001; G06K 15/02
USPC 358/1.9; 345/589

(57) ABSTRACT

A method for colorimetric rendering includes receiving, by a display device, an image that has been preprocessed for adjusting color and disregarding, by the display device, the preprocessing for adjusting color. The display device performs a colorimetric rendering transform at the time of display or print of the image by using an embedded colorimetric reference. A display device for colorimetric rendering of digital images is also provided.

### BACKGROUND

Digital images store image information as data files. These data files are easily shared between computing devices and can be displayed/printed in a variety of ways. Where desired, the digital images can be altered using automatic or manual interaction with photo editing software. However, there can be a number of challenges in capturing and maintaining color accuracy in these digital images.

The color in digital images can be influenced by a variety of factors, including the illumination of a target scene, the optics used to accept the light from the target, the detector converting the light into the digital image, automatic image processing within the acquiring device, other pre-processing steps, compression artifacts, deliberate alteration by a user, and other factors. Each of these factors may alter the color data stored in the digital image file so that the colors are not accurately reproduced from the target scene.

### BRIEF DESCRIPTION OF THE DRAWINGS

The accompanying drawings illustrate various examples of the principles described herein and are a part of the specification. The illustrated examples are merely examples and do not limit the scope of the claims.

FIGS. 1A-1C show scenes with physical colorimetric references, according to one example of principles described herein.

FIG. 2A is an image with embedded colorimetric reference, according to one example of principles described herein.

FIG. 2B shows an embedded colorimetric reference adjacent to a color swatch from the image shown in FIG. 2A, according to one example of principles described herein.

FIG. 2C shows another example of an embedded colorimetric reference, according to one example of principles described herein.

FIG. 3 is a diagram of a processing path for an image comprising an embedded colorimetric reference, according to one example of principles described herein.

FIG. 4 is a block diagram of a printing system for accurate colorimetric rendering of images with embedded colorimetric references, according to one example of principles described herein.

FIG. 5 is a flowchart of a method for colorimetric rendering of an image with an embedded colorimetric reference, according to one example of principles described herein.

Throughout the drawings, identical reference numbers designate similar, but not necessarily identical, elements.

### DETAILED DESCRIPTION

There are a variety of situations where accurate color reproduction in digital image is desired. For example, many companies demand that their corporate identities—things such as logos and product advertising—have a consistent look and color, no matter where the actual printing or display occurs. Other examples include taking digital images of products for advertising. If the color in the images is not an accurate representation of the color of the product, the consumers are not able to make informed purchasing decisions. For example, a woman may view an advertisement for a jacket. The color of the jacket is a significant consideration for the woman because the jacket will be worn in combination with clothing currently in the woman's wardrobe. If woman purchases the jacket with an incorrect understanding of the jacket's color, the jacket will not coordinate with her other clothing. Consequently, the woman may be dissatisfied with the purchase.

As discussed above, the color in digital images can be influenced by a variety of factors. One factor is the illumination of the target. The illumination affects the colors sensed by a camera. For example, illumination with fluorescent light can put a green or bluish cast to the colors while illumination with incandescent lights can produce a yellow tint in the colors. In some instances, such as in a photography studio, the illumination can be carefully controlled. However, there are a variety of situations where accurate color reproduction may be desired, but the illumination is less than ideal. Examples of situations where lighting may be less than ideal but accurate color reproduction is desired may include online sale of clothing and home furnishings where color matching is important and security situations where correct identification of a suspect's clothing color is important.

The camera taking the image is another significant factor in color reproduction. The camera optics can introduce color errors or may not focus enough light on the image detector for accurate measurement of color in a particular scene. The detector array of the camera can be a significant source of color error. The detector array may not be able to produce the full gamut of colors within the scene to a desired level of accuracy. For example, when a user uses a mobile phone to produce images of home furnishings inside the user's home, the color in the images may not accurately represent the color of the target scene.

To compensate for these inaccuracies, the camera may automatically apply a number of corrections, including dynamic range compensation, automatic white balancing, back light compensation, digital noise reduction, color balancing, and other operations. These operations may improve the visual characteristics of the image, but may further degrade the accuracy of the color reproduction.

When the user views an image, the user may make a variety of adjustments to the image using editing software. These adjustments may further change the color data in the image. Often the user makes these changes while viewing an inaccurate presentation of the image. For example, LCD displays have a number of limitations that may prevent accurate display of color information. Specifically, limitations in the brightness, viewing angle, contrast, color reproduction and gamma characteristics of an LCD display may introduce distortions in the image and colors.

Thus, the color data in an original digital image may not be an accurate representation of the colors in the target scene and subsequent manipulation of the digital image can further degrade the accuracy of the colors. In conventional processes, if the color is not accurately captured by the camera in the original image, it can be difficult or impossible to recover the accurate colors, because they were never known in the first place. Subsequent manipulation of the colors within the image further complicates the situation and can result in additional color accuracy being lost. This is complicated by display devices that do not accurately reproduce the colors in the image received by the display device.

One solution to color reproduction is the use of International Color Consortium (ICC) standards. The ICC standard uses an ICC profile that characterizes the color input device or color output device. The ICC profile is a system level descriptor that has to be correctly interpreted and applied throughout the system. These profiles describe the color attributes of a particular device or viewing requirement by defining a mapping between the device source and target color space. However, the ICC approach often fails because it requires the use of a single, ubiquitous and consistent color management system with a single, ubiquitous and consistent interpretation of colorimetric rendering by all imaging and computing devices, operating systems, applications and users. To obtain an accurate colorimetric rendition of an image would require that the image be captured and associated with a corresponding profile and tagged with a corresponding rendering intent. The profile and rendering intent must be correctly interpreted and applied throughout the system.

In practice, these assumptions are not often met. The color performance of many devices are not precisely measured or understood. Further, even for devices that where the color performance is understood, the device or manufacturer may not support an ICC profile for the device. Even where the manufacturer accurately characterizes the color performance of the device and uses an ICC profile, the user may ignore the ICC profile because they do not understand how to use it. Additionally, to maintain accurate color information, each device that manipulates or displays the image must be calibrated and appropriately use the ICC profile. In a typical scenario, many different devices may sequentially process the image data. If any device in the process chain fails to accurately account for the ICC profile data, the color accuracy of the image may be irreparably compromised. These limitations of the ICC approach make its use burdensome and an incomplete solution to reliably achieving a colorimetric rendering at the time of display or print.

A variety of other color management approaches also exist. However, these approaches use multiple criteria for color reproduction or rendering. For example, one color management approach may give preference to pleasing images over colorimetric accuracy. These various color management approaches may fail because they are not used, are incorrectly applied, or are used in multiple, conflicting ways.

The principles described below solve these challenges by disregarding previous color processing and performing an accurate colorimetric rendering transform at the time of display or print. In one implementation, a physical color reference is embedded into images. This physical color reference has known color attributes that can be used to calibrate the colors in the target scene. This allows the colors in the scene to be reproduced with high accuracy despite the limitations of the lighting, camera, or post processing steps. This provides a number of advantages including allowing high color accuracy using smaller cameras and less than ideal lighting situations.

Further, the image may pass through any number of post processing steps and still maintain accurate color reproduction. The embedded colorimetric reference points are used to directly determine the final display or print color rendering. If the previous color processing has been performed correctly the resulting difference will be minimal. However if any errors, inconsistencies or incompatibilities have been encountered, the final colorimetric rendering will achieve a significantly improved colorimetric rendition in spite of one or more known or unknown processing shortcomings.

In some examples, a printer, LCD screen, or other display device may recognize the physical color reference in the image and use it to automatically adjust the colors for accurate printing/display. Thus, regardless of the color errors introduced by the camera or processing of the digital image, the true colors in the image can be accurately printed/displayed.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

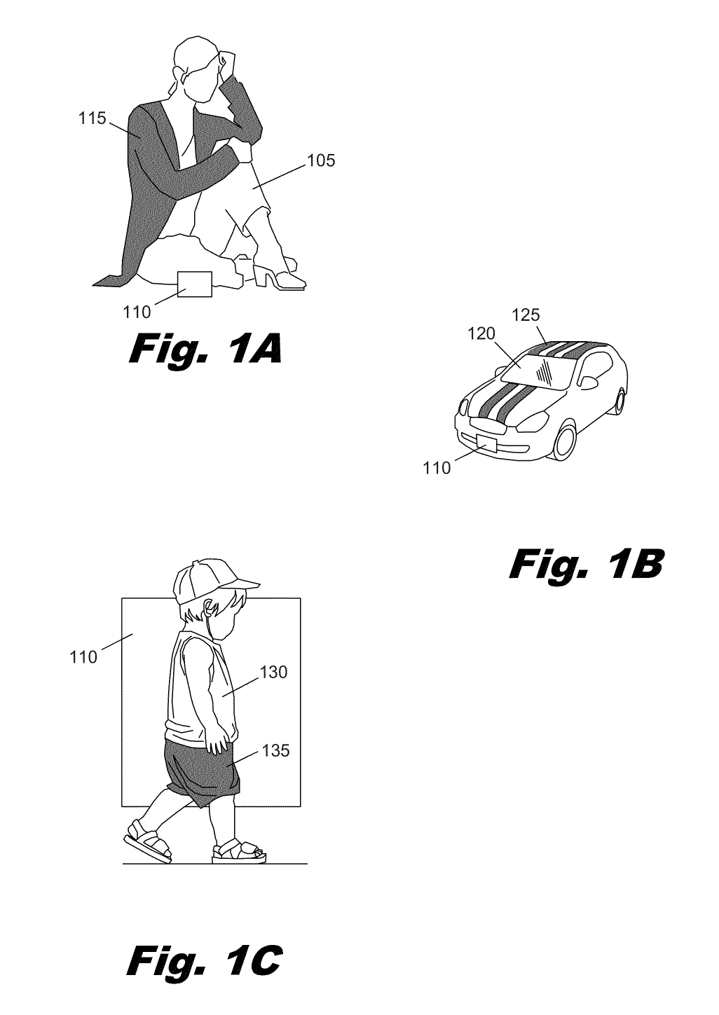

FIGS. 1A-1C show scenes with embedded colorimetric references. FIG. 1A is an image of woman (105) wearing a jacket (115) sitting with a physical colorimetric reference (110) propped against her knee. The colorimetric reference is a physical object (a card) with known color characteristics that is in the target scene and is exposed to substantially the same lighting conditions as the rest of the scene. For example, the colorimetric reference may include a variety of blocks with different hues, saturation, and lightness. Ideally, these blocks would describe specific color points within the gamut of colors in the target scene. Because the optical characteristics of the blocks are known, they can be used to identify colors within the target scene, even if the colors in the digital image of the scene and colorimetric reference are inaccurate. For example, several of the blocks in the colorimetric reference may have similar optical characteristics as the jacket (115) the woman is wearing. Thus, the color of the jacket can be accurately known by referencing the blocks in the colorimetric reference.

The colorimetric reference may take a variety of forms, sizes and shapes. For example, in FIG. 1B, the target scene includes a car (120) with a colorimetric reference (110) taking the place of the car's front license plate. The colorimetric reference allows the colors of the car to be accurately known and reproduced, including the colored strips (125) on the roof and hood of the car.

FIG. 1C shows a child (130) in shorts (135) walking in front of a colorimetric reference poster (110). The use of the colorimetric poster (110) allows the colors of the child's clothing, hat, sandals, hair and skin to be correctly identified, displayed and/or printed.

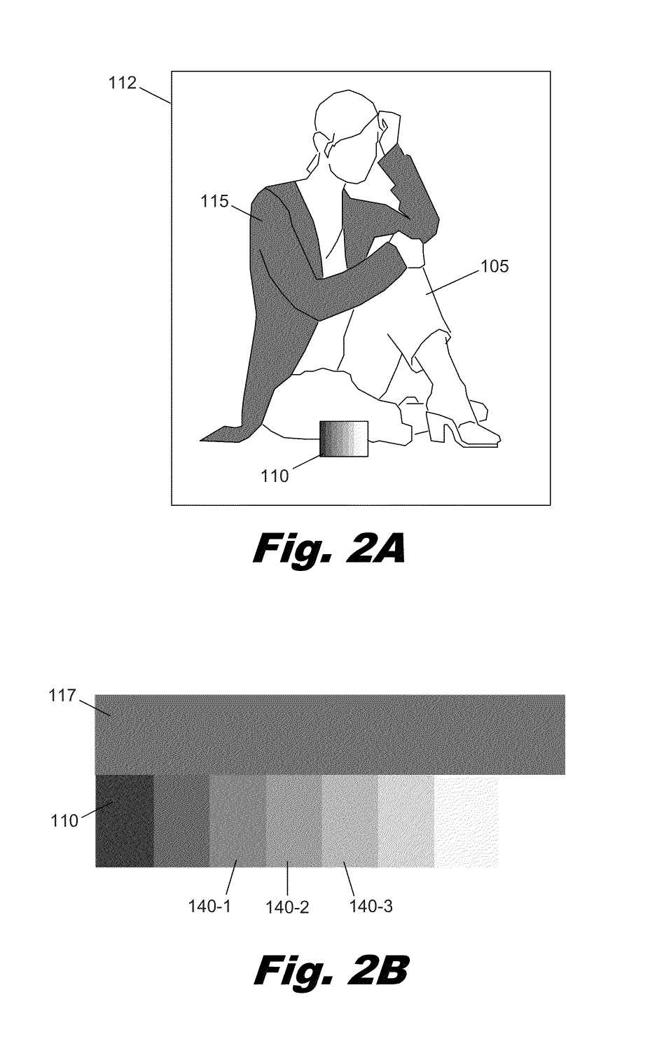

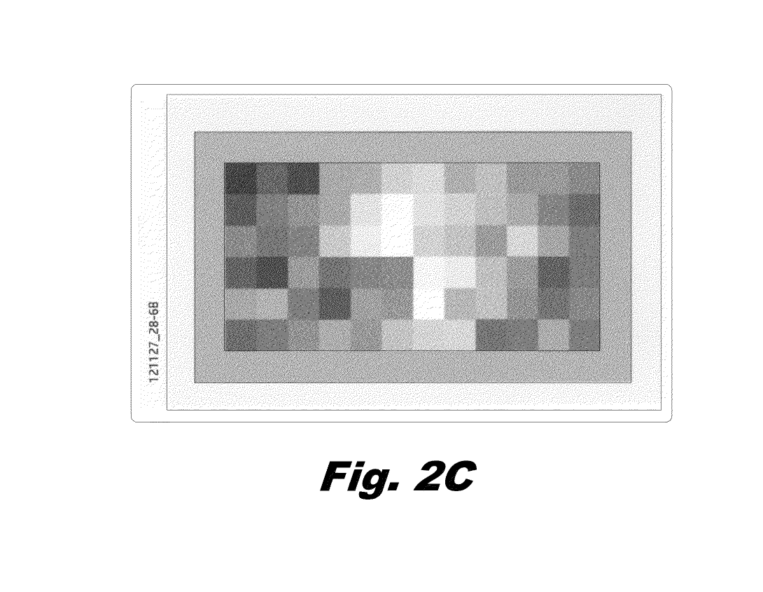

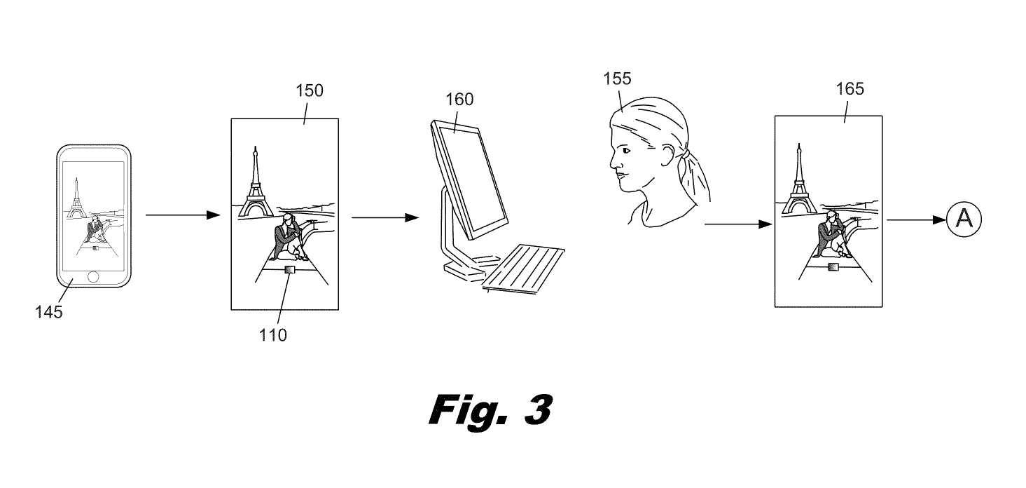

FIG. 2A is an image (112) of the target scene shown in FIG. 1A that includes a woman (105) in a jacket (115) and a simplified colorimetric reference (110). For purposes of illustration, the simplified colorimetric reference in this example includes a series of gray scale bars with differing tonalities. FIG. 2B shows an image of the embedded colorimetric reference adjacent to a color swatch (117) from the woman's jacket (115). Each of the bars (140) in the colorimetric reference has known optical characteristics. The color of the woman's jacket is similar, but not identical to three of the bars (140). The color of the jacket is most similar to the center bar (140-2) in the colorimetric reference (110). To precisely identify the color of the jacket, an interpolation of between the similar color bars can be used. For example, the interpolation may determine that the color of the jacket lies between a left bar (140-1) and the center bar (140-2).

The example given above is simplified. To accurately render colors in a color image, a multidimensional calibration can be used that accounts for the different hues and saturations that are present in image. For example, the colorimetric reference may include multiple rows of color blocks. Each block may have a different hue, lightness, and saturation to provide a range of reference points. The colorimetric reference may also include features such as distinctive borders that allow it to be more easily identified within an image. In one implementation, the colorimetric reference may be about the size of a credit card and contain 72 different color blocks. One example of this card is shown in FIG. 2C.

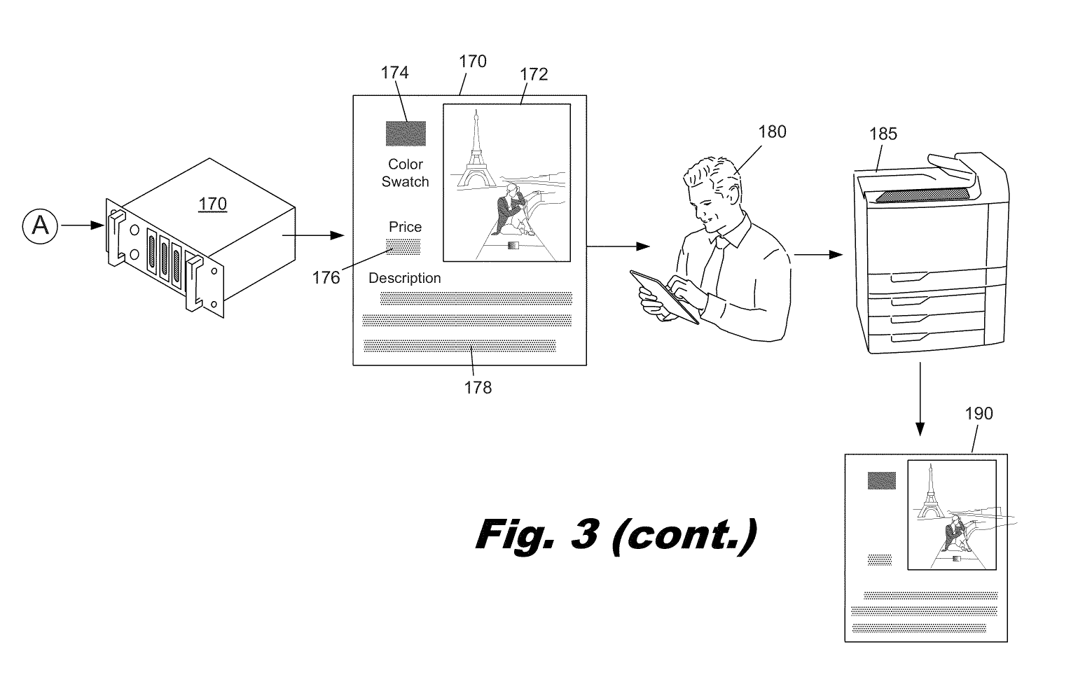

FIG. 3 is a diagram of a processing path for an image that includes an embedded colorimetric reference. In this example, a mobile device (145) is used to acquire image. Mobile devices have inherent size constraints that can limit the quality of images they produce. For example, cameras on mobile devices do not include large lens assemblies with significant of light gathering capability. To maintain the portability and light weight nature of the mobile device, the camera lens is often a compact fixed focus design. For similar reasons, large detector arrays are not included in the mobile device. Instead very small detector arrays are matched to the lens assemblies. These small detector arrays may sacrifice sensitivity and color accuracy for smaller size and reduced cost. The result is a convenient, lightweight camera that is incorporated within the envelope of the mobile device. The mobile device's memory and processor control the camera functions and store the image data. However, mobile devices will not typically acquire images with accurate colors.

The image (150) produced by this mobile camera (145) includes a woman, a famous landmark, and a colorimetric reference (110). Because the colorimetric reference is embedded in the image, the image can be colorimetrically corrected to include the accurate colors. The image (150) is sent to a computer (160) where the user (155) views the image on an LCD screen that may or may not accurately display the colors in the images. Based on this potentially inaccurate display of the image, the user (155) makes adjustments to the image. For example, the user (155) may adjust the colors to be more vivid and change the white balance. While the user (155) may find the image to be more attractive as displayed on the LCD screen, these adjustments further distort the colors in the image. The modified image (165) is sent to a server (170). The server (170) may provide any of a number of functions. In this example, the server (170) is an ecommerce server. The user (155) has decided to sell the jacket she bought in Paris on the ecommerce server.

The ecommerce website operators are aware that accurate color reproductions of products that are offered for sale on their website can be important for client satisfaction, particularly where the product will be color matched with other products the purchaser already owns. Consequently, the website operators are aware of colorimetric references and store data relating to the identification and colors displayed on colorimetric references.

After receiving an image, the server scans the image for an embedded colorimetric reference. If a colorimetric reference is identified, the server disregards the previous color processing of the image. The server then performs a colorimetric rendering transform using the embedded colorimetric reference. For example, server may apply a transformation that ensures that all the color blocks in the colorimetric reference are displayed according to their known values. If the color blocks in the colorimetric reference are accurately displayed, there is a high probability that other colors in the image are also accurately displayed. The server then uses the color corrected image to generate a web page (170) that include the color corrected image (172), a color swatch (174) of the product for sale, the desired sale price (176), and a description (178) of the product. The website may include a variety of other items, including a purchase button and other elements that are not shown.

A potential purchaser (180) views the web page (170) on a tablet and determines that he wants to show the jacket to one of his colleagues. The purchaser sends the web page (170) to a printer (185) with the instruction to print the webpage in accurate colors. The printer (185) then follows similar steps as the server to ensure that the colors in the web page are accurately printed. The printer (185) then prints the web page (190).

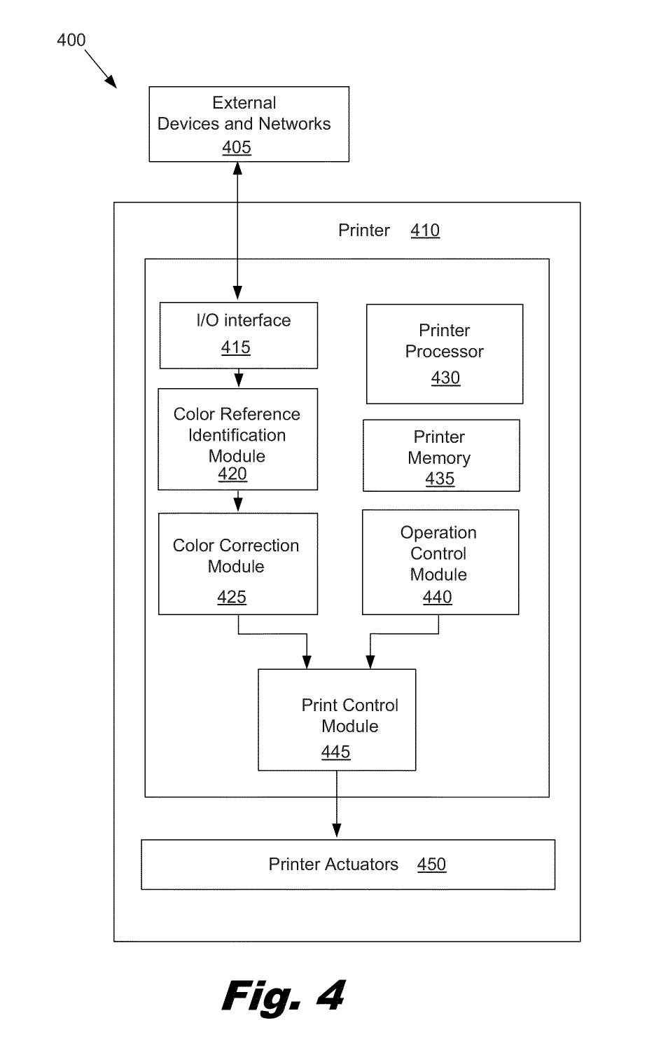

FIG. 4 is a block diagram of a printer for accurate colorimetric rendering of images with embedded colorimetric references. In this example, the printer (410) includes a printer processor (430), a printer memory (435), an I/O interface (415), a color reference identification module (420), a color correction module (425), operation control module (440), a printer control module (445) and a number of printer actuators (450). The printer processor (430) manages/executes these various interfaces, modules, and actuators according to programming stored in the printer memory (435). The printer memory (435) may include a variety of memory types (including volatile and nonvolatile memory) with a range of capacities. The printer memory (435) stores instructions/programs for execution by the processor and image data for printing.

The image data is initially received by the printer (410) from the external devices and/or networks (405). These external devices may include cameras, servers and other computing devices that communicate with the printer using physical media (such as memory cards inserted into the printer), wireless networks, wired networks, or a direct wireless or wired connections between a computing device and the printer (410). For example, an image photographed with a color reference can be distributed using heterogeneous networks with differing color managements systems, user knowledge, software, and operating systems. A variety of intermediate editing operations may be applied to the image to create the color image that is sent to a printer. For example, intermediate operations may include compression, saving in different formats, color adjustment and other modifications.

The I/O interface (415) manages communications with the external devices and networks and directs the image data to the printer memory (435) where it can be stored and accessed. The user may supply direction to the printer to correct the colors in the image. For example, the user may click on a button in a printer interface indicating that accurate color in the image is important and should be recovered.

The color reference identification module (420) analyses the image to determine if a colorimetric reference has been included in the image. The color reference identification module (420) can use a variety of techniques for detection of the colorimetric reference including computer vision functionality and homographic transforms. If no color reference is found by the identification module, the process stops and printing proceeds without color correction of the image. If a color reference is found, the color reference identification module may also identify the individual color blocks on the colorimetric reference.

The color correction module (425) retrieves known values of the color blocks in the colorimetric reference. These may be permanently stored in the printer memory, sent with the image data, or retrieved from an external database or computing device. The color correction module (425) uses the stored reference values to produce accurate colorimetry of the original target scene regardless of the range of unknown pre-processing considerations listed above. The color accurate version of the image is sent to the print control module (445). The print control module receives direction from an operation control module (440) and directs printer actuators (450) to accurately reproduce the image on a substrate. The printer actuators (450) may include actuators for dispensing ink or toner and for manipulation of various substrates. For example, the printer may be an inkjet printer, laser printer, solid ink printer, liquid electrostatic printer, or other printer.

This allows the printer to disregard all previous color processing and perform the colorimetric rendering transform at the time of printing. The embedded colorimetric reference points are used to directly determine the final display or print color rendering. If the previous color processing has been performed correctly the resulting difference will be minimal. However if any errors, inconsistencies or incompatibilities have been encountered the final colorimetric rendering will achieve a significantly improved colorimetric rendition in spite of one or more known or un-known processing shortcomings. If the accurate color rendition is not exactly what the user wants, the user can make modifications to the image without fear of losing the actual color information in the image.

Although FIG. 4 describes a printer as a display device for accurately rendering the original colors in an image using an embedded reference, a variety of other display devices could be used. For example, the display device such as a flat graphical display, three dimensional display, projection display, a computing device modifying the image, or other display device.

The principles described herein may take the form of a computer program product for colorimetric rendering. The computer program product includes a computer readable storage medium having computer readable program code embodied therewith. The computer readable storage medium may be any tangible medium that contain or store a program for use by or in connection with a computing device. For example the computer readable storage medium may be a portable computer diskette, hard disk, a random access memory, read only memory, an erasable programmable read-only memory such as EPROM or flash memory), an optical storage device, a magnetic storage device or any suitable combination of the foregoing. The computer readable program code is configured to receive, by a display device, an image that has been preprocessed for adjusting color, the image including an embedded colorimetric reference. The computer readable program code disregards the preprocessing for adjusting color and performs a colorimetric rendering transform at the time of display or print of the image by using the embedded colorimetric reference. The computer readable program code for carrying out operations according to the principles described herein may be written in any suitable programming language.

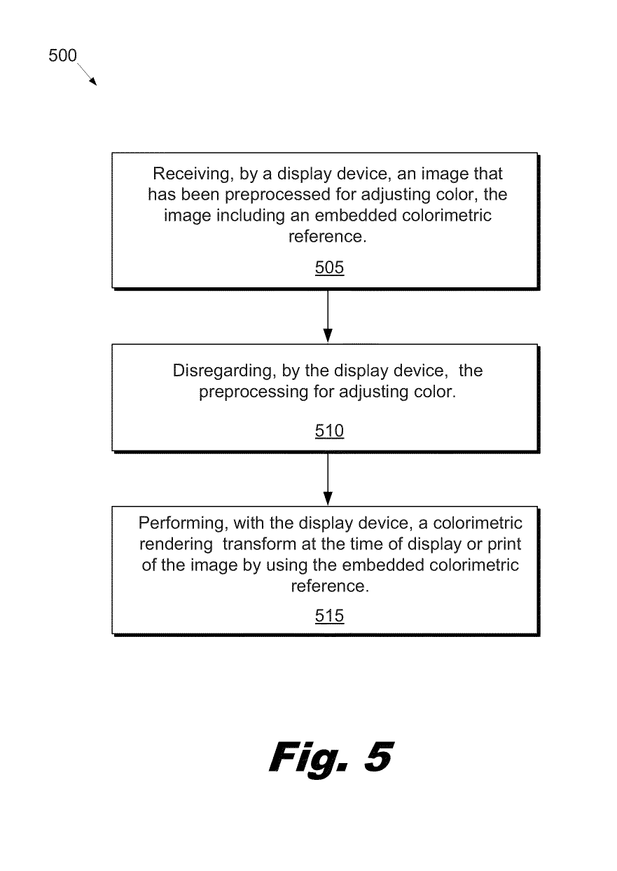

FIG. 5 is a flowchart of a method for colorimetric rendering of an image with an embedded colorimetric reference. The method may include a number preliminary steps, including placing a physical colorimetric reference in a field of view of a camera; and taking an image of a target scene that includes the physical colorimetric reference. This produces an image with an embedded colorimetric reference. For example, the physical colorimetric reference may be made up of a plurality of color samples with known characteristics.

The display device receives the image that has been preprocessed for adjusting color (block 505). The image includes an embedded colorimetric reference. The embedded colorimetric reference includes at least one pixel in the image file of an object (a colorimetric reference) that has a known color. The at least one pixel may or may not accurately represent the known color when the image is generated. As discussed above, a colorimetric reference may be embedded by taking an image of object with one or more known color characteristics. The display device may be a printer that prints the image on a substrate for display, a screen that directly displays the image or other device that produces an image viewable by a user. The display device disregards the previously performed preprocessing that adjusted the color in the image (block 510). The display device then performs a colorimetric rendering transform at the time of display or print of the image by using the embedded colorimetric reference (block 515). In one implementation, this colorimetric rendering transform includes recognizing the embedded colorimetric reference in the image and using the embedded colorimetric reference to correct colors in the scene. The known values of the color blocks of the colorimetric reference may be stored in a memory of the display device or may be retrieved from a remote computing device. The unknown colors in the image are identified by interpolating between the known colors of the embedded colorimetric reference. The colors in the image are then adjusted to be accurate using the known color values of embedded colorimetric reference.

Thus, the principles above describe an image with a color of interest and a colorimetric reference, such as a color chart. Images captured with both a color of interest and a specific color chart can then be transmitted, processed, edited and shared using a full range of networks, devices and users. Unknown, intermediate color transformations and adjustments may occur, including errors and incorrectly applied color transforms. A range of display devices, such as a graphical display or printer, can be provided with storage and processing components to recognize the reference colors in the image and then apply a color correction to the color of interest to achieve an accurate colorimetric rendition at the time of display or print. The final corrected color is therefore a more consistent colorimetric match with respect to the original color of interest regardless of any unknown pre-processing steps. This is a significantly more robust technique for accurate color reproduction and display than previous techniques. This process assumes only that images are captured with the reference colors and that the display device can perform the colorimetric reference detection and color transformation.

These principles allow for a more consistently accurate colorimetric rendering for colors of interest without requiring a single, ubiquitous and consistent color management system used by all computing platforms, applications and users. This is a substantial advantage in many domains, such as ecommerce, in which there is a need to accurately display or print product colors, but as yet has no single, end-to-end solution. These advantages are enabled by consistent use of reference colors at the time of capture which are then found and used to perform the final color rendering at the time of display or print. This is an elegant and consistently performing solution to the complex problem of accurate color reproduction.

The preceding description has been presented only to illustrate and describe examples of the principles described. This description is not intended to be exhaustive or to limit these principles to any precise form disclosed. Many modifications and variations are possible in light of the above teaching.

1. A method for colorimetric rendering comprising:
receiving, by a display device, an image that has been preprocessed for adjusting color, the image including an embedded colorimetric reference;
disregarding, by the display device, the preprocessing for adjusting color; and
performing, with the display device, a colorimetric rendering transform at the time of display or print of the image by using the embedded colorimetric reference.

2. The method of claim 1, in which performing a colorimetric rendering comprises:
recognizing the embedded colorimetric reference in the image; and
using the embedded colorimetric reference to correct colors in the scene.

3. The method of claim 1, further comprising:
placing a physical colorimetric reference in a field of view of a camera; and
taking a picture of a target scene that includes the physical colorimetric reference with the camera to produce the image with the embedded colorimetric reference.

4. The method of claim 3, in which the physical colorimetric reference comprises a plurality of known color samples.

5. The method of claim 1, in which the display device comprises a printer, the method further comprising printing the image after performing the colorimetric transform.

6. The method of claim 1, in which the display device comprises a graphical display, the method further comprising displaying the image by the graphical display after performing the colorimetric transform.

7. The method of claim 1, further comprising storing data identifying accurate color values of color blocks in the physical colorimetric reference.

8. The method of claim 7, in which the colorimetric rendering transform comprises:
identifying colors in the image by interpolating between colors of the embedded colorimetric reference; and
adjusting the identified colors to accurate colors using the accurate color values of the color blocks.

9. A computer program product for colorimetric rendering, the computer program product comprising:
a computer readable storage medium having computer readable program code embodied therewith, the computer readable program code comprising:
computer readable program code to receive, by a display device, an image that has been preprocessed for adjusting color, the image including an embedded colorimetric reference;
computer readable program code to receive an image that has been preprocessed for adjusting color, the image including an embedded colorimetric reference;
computer readable program code to disregard the preprocessing for adjusting color;
computer readable program code to perform a colorimetric rendering transform at the time of display or print of the image by using the embedded colorimetric reference.

10. A display device for colorimetric rendering of digital images comprising:
a processor;
a memory;
an I/O interface for receiving a digital image from an external entity, the digital image being stored in the memory;
a color reference identification module executed by the processor, the color reference identification module for identifying a colorimetric reference in the digital image; and
a color correction module executed by the processor for disregarding previous color processing operations and for color correcting colors in the digital image to produce a color corrected image.

11. The device of claim 10, in which the device is a printer for printing the color corrected image.

12. The device of claim 11, further comprising a print control module for receiving the color corrected image and for controlling printer actuators to produce a print of the color corrected image.

13. The device of claim 10, in which the device is a display device for displaying the color corrected image.

14. The device of claim 10, further comprising data regarding true colors of color blocks that make up the colorimetric reference stored in the memory.

15. The device of claim 10, in which the colorimetric reference comprises a distinctive colored border to aid in identification of the colorimetric reference by the color reference identification module.
